(19) United States
(12) Patent Application Publication
(10) Pub. No.: US 2025/0312714 A1
(43) Pub. Date: Oct. 9, 2025

(54) AIR FILTER SYSTEM

(71) Applicant: Juan Ehringer, Gainesville, FL (US)

(72) Inventor: Juan Ehringer, Gainesville, FL (US)

(21) Appl. No.: 18/625,606

(22) Filed: Apr. 3, 2024

(51) Int. Cl. B01D 35/30; B01D 29/58

(52) U.S. Cl. CPC B01D 35/301; B01D 29/58; B01D 2201/302

(57) ABSTRACT

In general, the disclosed filter system can include a primarily metal body defining a plurality of channels in fluid communication with one or more filter assemblies. An inlet of the metal body can be connectable to an air compressor or similar fluid source. An outlet of the metal body can be connectable to a pneumatic tool, pneumatic equipment, or an air distribution system. The filter system can include one or more plugs that are constructed and arranged to fluidly seal selected portions of a main channel to form a fluid-tight pathway through the plurality of channels and the filter assemblies.

### TECHNICAL FIELD

The embodiments generally relate to the field of fluid filter systems. In particular, some embodiments relate to a three-stage air filter system. Some embodiments relate to a two-stage air filter system. Some embodiments relate to a one-stage air filter system.

### BACKGROUND

Different individual filters for filtering air from an air compressor commonly have multiple separate components that have to be mechanically fastened with screws, which introduces more pathways for air leakage.

There is a need for a filter system that is made with fewer components, to reduce or prevent pathways for air leakage.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

In general, the disclosed filter system can include a primarily metal body defining a plurality of channels in fluid communication with one or more filter assemblies. An inlet of the metal body can be connectable to an air compressor or similar fluid source. An outlet of the metal body can be connectable to a pneumatic tool, pneumatic equipment, or an air distribution system. The filter system can include one or more plugs that are constructed and arranged to fluidly seal selected portions of a main channel to form a fluid-tight pathway through the plurality of channels and the filter assemblies.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates an illustrative depiction of a filter system as disclosed herein;

FIG. 2 illustrates an illustrative depiction of a cross section of a body of a filter system as disclosed herein;

FIG. 3 illustrates an illustrative depiction of a body of a filter system as disclosed herein;

FIG. 4 illustrates an illustrative depiction of a bottom view of a filter system as disclosed herein;

FIG. 5 illustrates an illustrative depiction of a pressure regulator at an outlet of a filter system as disclosed herein;

FIG. 6 illustrates an illustrative depiction of a filter status indicator as disclosed herein;

FIG. 7 illustrates an illustrative depiction of a plug of a filter system as disclosed herein;

FIG. 8 illustrates an illustrative depiction of filter systems having different combinations of filter assemblies as disclosed herein;

FIG. 9 illustrates an illustrative depiction of a cross section of a body of a filter system as disclosed herein;

FIG. 10 illustrates an illustrative depiction of a cross section of a body of a filter system as disclosed herein; and

FIG. 11 illustrates an illustrative depiction of a plug of a filter system as disclosed herein.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described product or methods of use. Any specific details of the embodiments are used for demonstration purposes only and no unnecessary limitations or inferences are to be understood from there.

It is noted that the embodiments reside primarily in combinations of components and procedures related to the products. Accordingly, the product and components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments discloses herein relate to a filter system that can include a body defining a plurality of channels in fluid communication with one or more filter assemblies. In some embodiments, the body can be made primarily of metal. The body can be made from a single block of metal. In some embodiments, the body can be made primarily of plastic (e.g., engineering plastic). An inlet of the body can be connectable to an air compressor or similar fluid source. An outlet of the body can be connectable to a pneumatic tool, pneumatic equipment, or an air distribution system. The filter system can include one or more plugs that are constructed and arranged to fluidly seal selected portions of a main channel to form a fluid-tight pathway through the plurality of channels and the filter assemblies. The filter assemblies can be fluidly connected in series by the plurality of channels of the body.

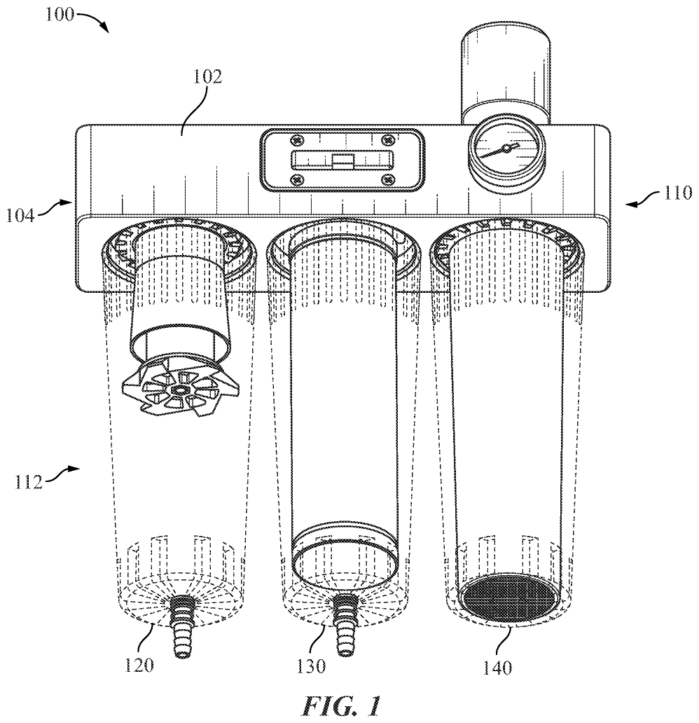

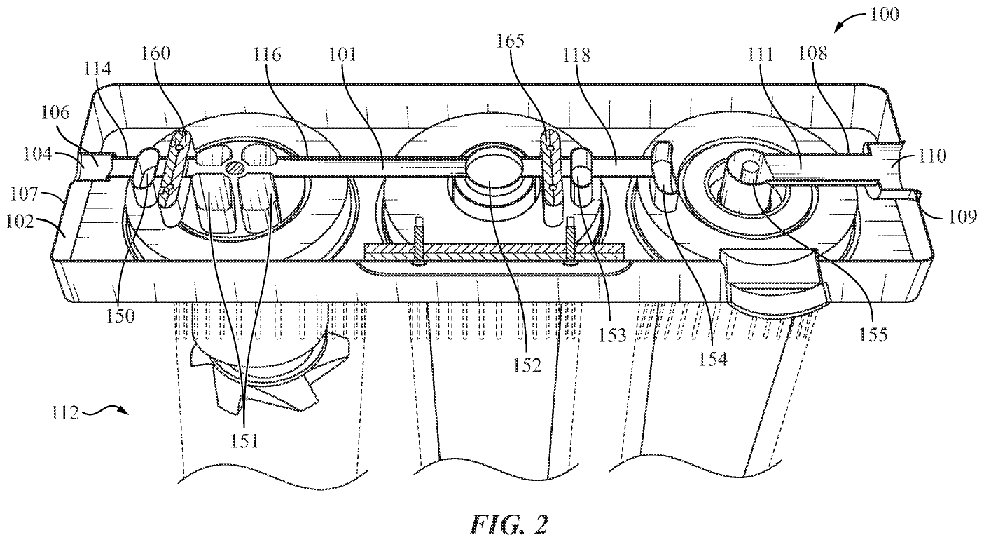

Referring to FIGS. 1 and 2, a filter system 100 can include a body 102 defining at least an inlet 104, a first main channel 106, a second main channel 108, and an outlet 110. In some embodiments, the inlet 104 can be configured to receive an air flow from an air compressor (not shown) or another fluid source. In some embodiments, the body 102 can be a primarily metal body. In some embodiments, the body 102 can be made from a single block of metal. In some embodiments, the body 102 can be a unibody.

In some embodiments, the inlet 104 and at least a first portion 114 of the first main channel 106 can be in fluid communication. In some embodiments, the first main channel 106 and the inlet 104 can be formed by drilling an elongate hole into a first side 107 of the body 102. In some embodiments, an inner surface 101 of the body 102 can define the first main channel 106.

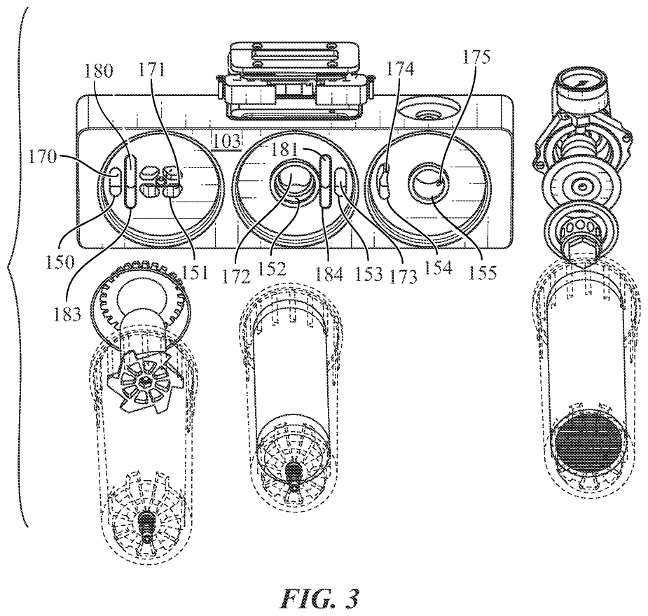

Referring to FIGS. 2 and 3, in some embodiments, the body 102 can further define a first slot 180 having a first slot opening 183 in an outer surface 103 of the body 102 and positioned between the first portion 114 of the first main channel 106 and a second portion 116 of the first main channel 106. In some embodiments, the outer surface 103 of the body 102 can include any recessed surfaces. In some embodiments, at least portions of the outer surface 103 of the body 102 can face outward. The first slot 180 can be constructed and arranged to receive a first plug 160 between the first portion 114 of the first main channel 106 and the second portion 116 of the first main channel 106. The first plug 160 can be constructed and arranged to fluidly seal the first portion 114 of the first main channel 106 from the second portion 116 of the first main channel 106.

In some embodiments, the body 102 can further define a first secondary channel 150 that is constructed and arranged to be in fluid communication with at least the first portion 114 of the first main channel 106. In some embodiments, the first secondary channel 150 can have a first opening 170 in the outer surface 103 of the body 102.

In some embodiments, the body 102 can further define a second secondary channel 151 that is constructed and arranged to be in fluid communication with at least the second portion 116 of the first main channel 106. In some embodiments, the second secondary channel 151 can have a second opening 171 in the outer surface 103 of the body 102.

In some embodiments, the body 102 can further define a third secondary channel 152 that is constructed and arranged to be in fluid communication with at least the second portion 116 of the first main channel 106. In some embodiments, the third secondary channel 152 can have a third opening 172 in the outer surface 103 of the body 102.

In some embodiments, the body 102 can further define a second slot 181 having a second slot opening 184 in the outer surface 103 of the body 102 and positioned between the second portion 116 of the first main channel 106 and a third portion 118 of the first main channel 106. The second slot 181 can be constructed and arranged to receive a second plug 165 between the second portion 116 of the first main channel 106 and the third portion 118 of the first main channel 106. The second plug 165 can be constructed and arranged to fluidly seal the second portion 116 of the first main channel 106 from the third portion 118 of the first main channel 106.

In some embodiments, the body 102 can further define a fourth secondary channel 153 that is constructed and arranged to be in fluid communication with at least the third portion 118 of the first main channel 106. In some embodiments, the fourth secondary channel 153 can have a fourth opening 173 in the outer surface 103 of the body 102.

In some embodiments, the body 102 can further define a fifth secondary channel 154 that is constructed and arranged to be in fluid communication with at least the third portion 118 of the first main channel 106. In some embodiments, the fifth secondary channel 154 can have a fifth opening 174 in the outer surface 103 of the body 102.

In some embodiments, the body 102 can further define a sixth secondary channel 155 that is constructed and arranged to be in fluid communication with at least the outlet 110. In some embodiments, the sixth secondary channel 155 can have a sixth opening 175 in the outer surface 103 of the body 102. In some embodiments, a second main channel 108 is in fluid communication with the sixth secondary channel 155 and the outlet 110. In some embodiments, the second main channel 108 and the outlet 110 can be formed by drilling an elongate hole into a second side 109 of the body 102. In some embodiments, an inner surface 111 of the body 102 can define the second main channel 108.

In some embodiments, any secondary channel can include one or more secondary channels.

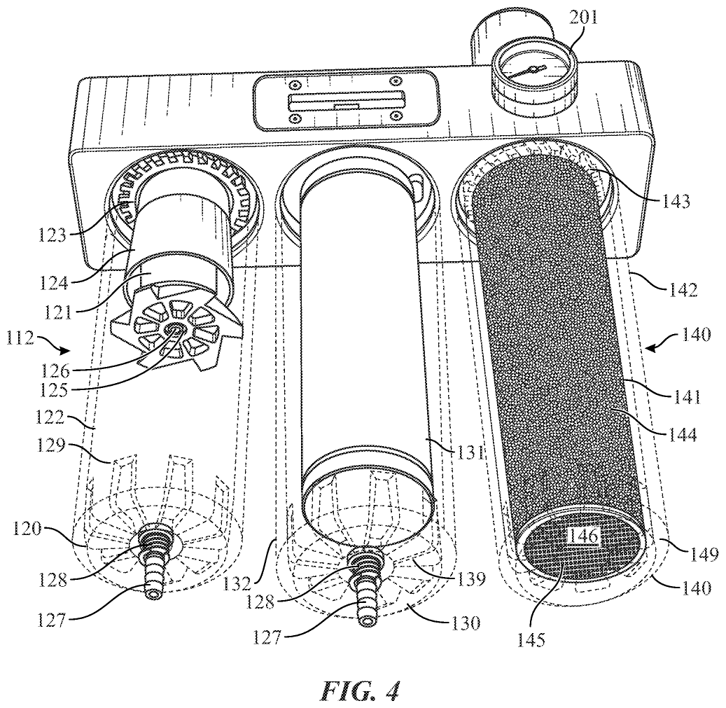

Referring to FIGS. 3 and 4, the body 102 can be attached to a plurality of filter assemblies 112. In some embodiments, the plurality of filter assemblies 112 can include a first filter assembly 120, a second filter assembly 130, a third filter assembly 140, or any combination thereof. In some embodiments, the first filter assembly 120 can be replaced by the second filter assembly 130 or the third filter assembly 140. In some embodiments, the second filter assembly 130 can be replaced by the first filter assembly 120 or the third filter assembly 140. In some embodiments, the third filter assembly 140 can be replaced by the first filter assembly 120 or the second filter assembly 130.

In some embodiments, the first filter assembly 120 can include a first filter 121 and a first container 122. In some embodiments, the first filter 121 can be constructed and arranged to be in sealed communication (e.g., fluidly sealed communication) with the body 102. In some embodiments, the first filter 121 can be in threaded communication with the body 102. In some embodiments, the first filter 121 can be attached to the body 102 by a screw 126 and nut 125. In some embodiments, the first filter 121 can cover at least the second opening 171 of the second secondary channel 151. In some embodiments, an inside of the first filter 121 can be in fluid communication with the second secondary channel 151. In some embodiments, the first filter 121 can be positioned at least partially inside the first container 122.

In some embodiments, the first filter 121 can include a particulate filter that is constructed and arranged to capture solid and liquid particles of approximately 5 microns or larger. In some embodiments, the first filter 121 can comprise any suitable filter medium, such as a sintered filter medium comprising a metal or alloy. For example, the first filter 121 can be a sintered metal filter. In some embodiments, the metal or alloy can include, for example, brass, steel, bronze, nickel, titanium, copper, zinc, or any combination thereof.

In some embodiments, the first container 122 can be constructed and arranged to be in sealed communication (e.g., fluidly sealed communication) with the body 102 and positioned under the first opening 170 of the first secondary channel 150 and the second opening 171 of the second secondary channel 151. The first container 122 can be in threaded communication with the body 102. In some embodiments, an inside 129 of the first container 122 can be in fluid communication with the first secondary channel 150. In some embodiments, the inside 129 of the first container 122 and the first secondary channel 150 can be in filtered fluid communication with the second secondary channel 151. During operation, a fluid can flow from the first secondary channel 150 to the inside 129 the first container 122, flow into and be filtered by the first filter 121, and flow into the second secondary channel 151.

In some embodiments, first flow guide blades 123 can be positioned under the first secondary channel 150 and the second secondary channel 151. The first flow guide blades 123 can be positioned inside the first container 122. The first flow guide blades 123 can be constructed and arranged to guide a fluid flowing from the first secondary channel 150 and into the first container 122 so that the fluid rotationally flows around the first filter 121 inside the first container 122.

In some embodiments, a shield 124 can be constructed and arranged to surround at least a portion of the first filter 121. The shield 124 can be constructed and arranged to condense moisture or water vapor in a fluid flowing from the first secondary channel 150 and into the first container 122. The shield 124 can be constructed and arranged to prevent any condensed moisture or water vapor from contacting the first filter 121. The shield 124 can be constructed and arranged to prevent any condensed moisture or water vapor from entering the second opening 171 of the second secondary channel 151.

In some embodiments, a drain pin 127 and spring 128 can be constructed and arranged to controllably drain any condensed moisture or water vapor collected at a bottom of the first container 122.

In some embodiments, the second filter assembly 130 can include a second filter 131 and a second container 132. In some embodiments, the second filter 131 can be constructed and arranged to be in sealed communication (e.g., fluidly sealed communication) with the body 102. In some embodiments, the second filter 131 can be in threaded communication with the body 102. In some embodiments, the second filter 131 can cover at least the third opening 172 of the third secondary channel 152. In some embodiments, an inside of the second filter 131 can be in fluid communication with the third secondary channel 152. In some embodiments, the second filter 131 can be positioned at least partially inside the second container 132.

The second filter 131 can include a coalescing filter constructed and arranged to capture solid particles and liquid particles that are approximately 0.01 microns or larger. The second filter 131 can include any suitable filter medium to capture particles that are approximately 0.01 microns or larger.

In some embodiments, the second container 132 can be constructed and arranged to be in sealed communication (e.g., fluidly sealed communication) with the body 102 and positioned under the third opening 172 of the third secondary channel 152 and the fourth opening 173 of the fourth secondary channel 153. The second container 132 can be in threaded communication with the body 102. In some embodiments, an inside 139 of the second container 132 can be in fluid communication with the fourth secondary channel 153. In some embodiments, the third secondary channel 152 can be in filtered fluid communication with the inside 139 of the second container 132 and the fourth secondary channel 153. During operation, a fluid can flow from the third secondary channel 152 into the second filter 131, flow out of and be filtered by the second filter 131, and flow into the fourth secondary channel 153.

In some embodiments, a drain pin 127 and spring 128 can be constructed and arranged to controllably drain any fluid collected at a bottom of the second container 132.

In some embodiments, the third filter assembly 140 can include an inner container 141 and an outer container 142. The inner container 141 can be at least partially inside the outer container 142. In some embodiments, the third filter assembly 140 can be a dryer assembly that is constructed and arranged to capture moisture or water vapor from a fluid flowing through the third filter assembly 140. In some embodiments, the inner container 141 can contain at least desiccant material 144. In some embodiments, the desiccant material can include a plurality of desiccant beads 144. The plurality of desiccant beads 144 can include any suitably shaped beads, such as, for example, spherical beads, irregularly shaped beads, or any combination thereof. In some embodiments, the plurality of desiccant beads 144 can be made primarily of silica gel. In some embodiments, the desiccant material 144 can include any other suitable desiccant (and e.g., not necessarily beads), which can include powders and porous materials.

The inner container 141 can be constructed and arranged to be in sealed communication (e.g., fluidly sealed communication) with the body 102 and positioned under the sixth opening 175 of the sixth secondary channel 155. The sixth secondary channel 155 can be in fluid communication with an inside of the inner container 141. The sixth secondary channel 155 can be covered by the inner container 141. The inner container 141 can be in threaded communication with the body 102. The inner container 141 can have one or more holes 145 arranged, for example, at a bottom of the inner container 141. The inner container 141 can include a mesh filter 146 positioned at the bottom thereof. The mesh filter 146 can include the one or more holes 145. A size of each of the one or more holes 145 can be smaller than a size of each desiccant bead 144 so that the desiccant beads 144 do not fall through the one or more holes 145.

The outer container 142 can be constructed and arranged to be in sealed communication (e.g., fluidly sealed communication) with the body 102 and positioned under the fifth opening 174 of the fifth secondary channel 154 and the sixth opening 175 of the sixth secondary channel 155. The outer container 142 can be in threaded communication with the body 102.

In some embodiments, an inside 149 of the outer container 142 can be in fluid communication with the fifth secondary channel 154. In some embodiments, the fifth secondary channel 154 and the inside 149 of the outer container 142 can be in filtered fluid communication with the sixth secondary channel 155. During operation, a fluid can flow from the fifth secondary channel 154 into the outer container 142, flow through the one or more holes in the inner container 141 and into the inner container 141, and flow into the sixth secondary channel 155.

In some embodiments, second flow guide blades 143 can be positioned under the fifth secondary channel 154 and the sixth secondary channel 155. The second flow guide blades 143 can be positioned inside the outer container 142. The second flow guide blades 143 can be constructed and arranged to guide a fluid flowing from the fifth secondary channel 154 and into the outer container 142 so that the fluid rotationally flows around the inner container 141.

In some embodiments, a pressure gauge 201 can be positioned in the body 102 and above the outer container 142. The pressure gauge 201 can be in fluid communication with the second main channel 108. The pressure gauge 201 can be constructed and arranged to measure pressure inside the second main channel 108. In some embodiments, the pressure inside the second main channel 108 is substantially the same as the pressure at the outlet 110.

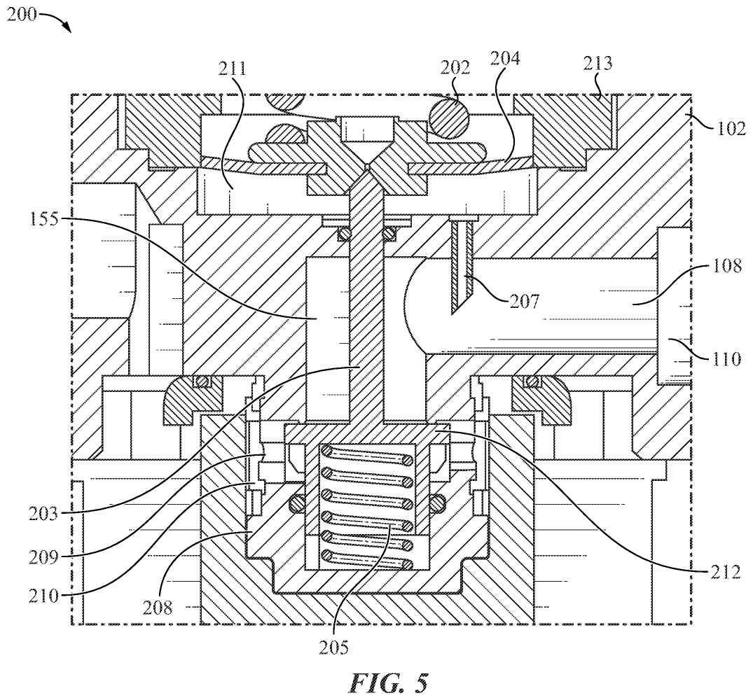

Referring to FIG. 5, a pressure regulator 200 can be in fluid communication with the second main channel 108. The pressure regulator 200 can be constructed and arranged to regulate the pressure in the second main channel 108. The pressure regulator 200 can regulate the pressure inside the second main channel 108 to be within a predetermined range of pressures.

The pressure regulator 200 can include a diaphragm 204 in mechanical communication with a first spring 202 that applies a downward force to the diaphragm 204. In some embodiments, the diaphragm 204 can be fully seated within the body 102. A central portion of the diaphragm 204 is constructed and arranged to move up and down within a chamber 211 of a diaphragm housing 213. The diaphragm housing 213 is in sealed communication with the body 102. A vent 207 is in fluid communication with the chamber 211 and the second main channel 108. A stem 203 mechanically connects the diaphragm 204 to a valve 212 that opens and closes the sixth secondary channel 155. A second spring 205 is in mechanical communication with the valve 212 and applies an upward force to the value 212. The pressure regulator 200 can include a bottom container 208 that is in sealed communication with the body 102. The bottom container 208 can contain at least the second spring 205. The bottom container 208 can include one or more holes 209 that are in fluid communication with an inside of the inner container 141.

When the pressure in the second main channel 108 meets a predetermined threshold, the pressure causes the diaphragm 204 to move upward, causing the valve 212 to move upward and close the sixth secondary channel 155. When the pressure in the second main channel 108 does not meet the predetermined threshold, the spring 202 causes the diaphragm 204 to move downward, causing the valve 212 to move downward and open the sixth secondary channel 155. When the sixth secondary channel 155 is open, the one or more holes 209 are in fluid communication with the sixth secondary channel 155. A mesh filter 210 can cover the one or more holes 209 to prevent any desiccant material 144 from entering the sixth secondary channel 155 while allowing any fluid to enter therethrough.

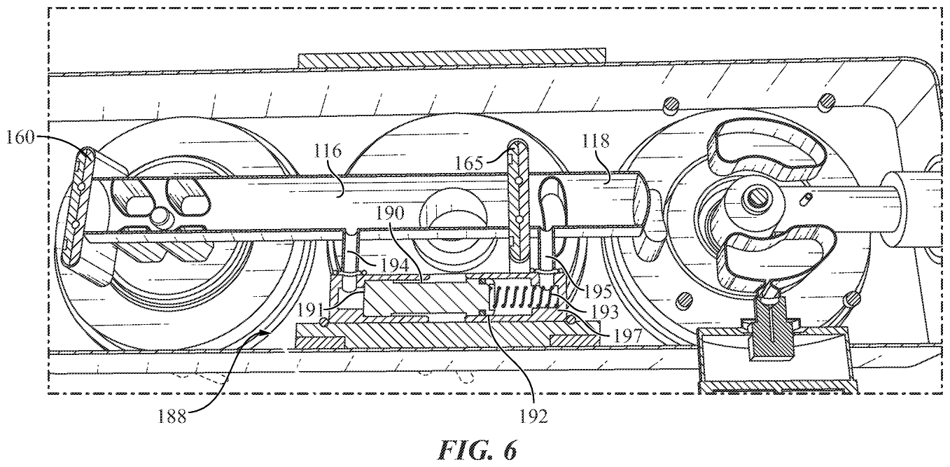

Referring to FIG. 6, a filter status indicator 188 can include a piston 190 having a first portion 191 and a second portion 192. The first portion 191 of the piston 190 can be in fluid communication with a first indicator channel 194 and at least the second portion 116 of the first main channel 106. The second portion 192 of the piston 190 can be in fluid communication with a second indicator channel 195 and at least the third portion 118 of the first main channel 106. A spring 193 is in mechanical communication with the second portion 192 of the piston and a housing 197. The spring 193 applies a force to push the piston 190 toward a first direction (e.g., left). As the second filter 131 filters fluid, the second filter 131 can become more clogged with captured particles. As the second filter 131 becomes more clogged, the pressure in the second portion 116 of the first main channel 106 can become greater than the pressure in the third portion 118 of the first main channel 106 during operation, causing the piston 190 to move in a second direction opposite the first direction. The piston 190 can be constructed and arranged to move in response to an increase in a first pressure in the second portion 116 of the first main channel 106 relative to a second pressure in the third portion 118 in the first main channel 106. The piston 190 moving past a predetermined position can indicate that the second filter 131 should be replaced.

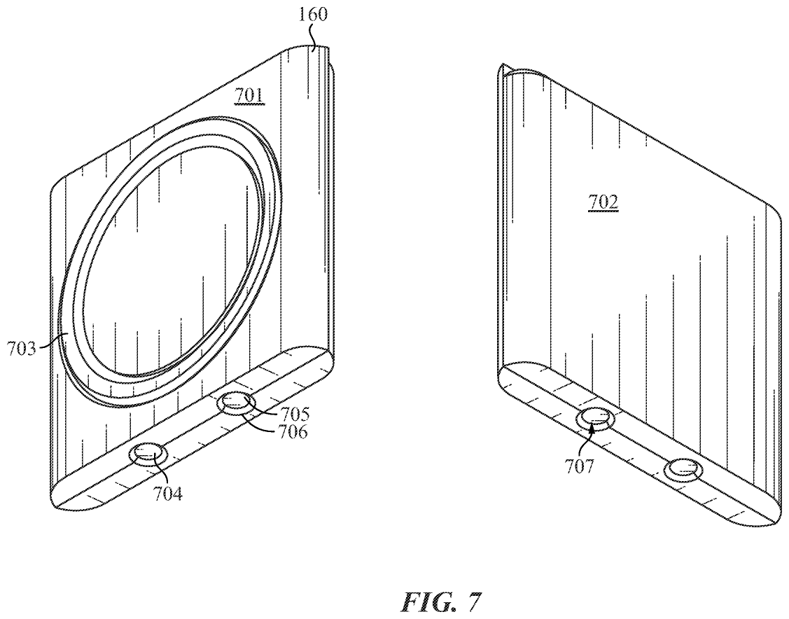

Referring to FIG. 7, the first plug 160 (and/or the second plug 165) can include a first plate 701 and a second plate 702. The first plate 701 can have first grooves 705 on a first side thereof. A seal 703 can be disposed on a second side of the first plate 701 opposite the first side. The seal 703 can be constructed and arranged to fluidly seal the first portion 114 of the first main channel 106 from the second portion 116 of the first main channel 106. The seal 703 can include an o-ring or a gasket. The second plate 702 can have second grooves 706 on a first side thereof. Tapered pins 704 can be received by the grooves 705/706. The first plate 701 and the second plate 702 are constructed and arranged to be joined together so that the first grooves 705 are aligned with the second grooves 706 to form apertures 707 that receive the tapered pins 704.

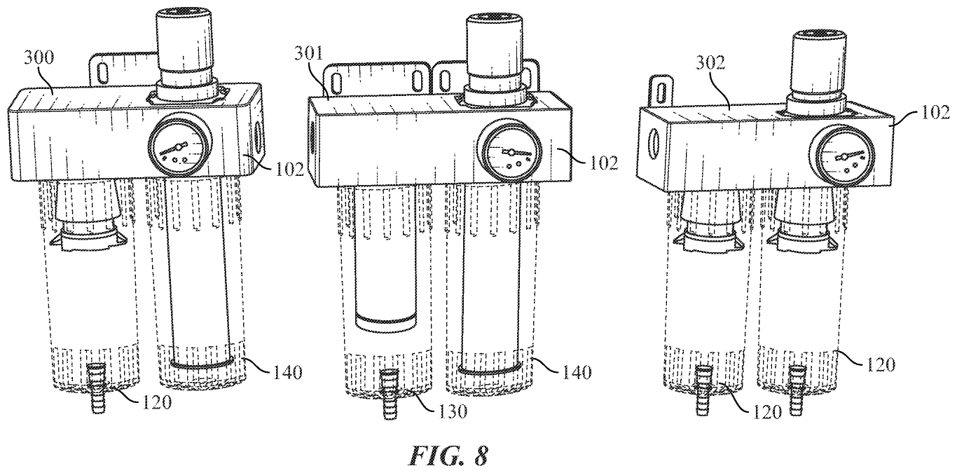

Referring to FIG. 8, a first filter system 300, a second filter system 301, and a third filter system 302 are shown. The first filter system 300 includes a body 102 in sealed communication with the first filter assembly 120 and the third filter assembly 140. The second filter system 301 includes a body 102 in sealed communication with the second filter assembly 130 and the third filter assembly 140. The third filter system 302 includes a body 102 in sealed communication with two first filter assemblies 120.

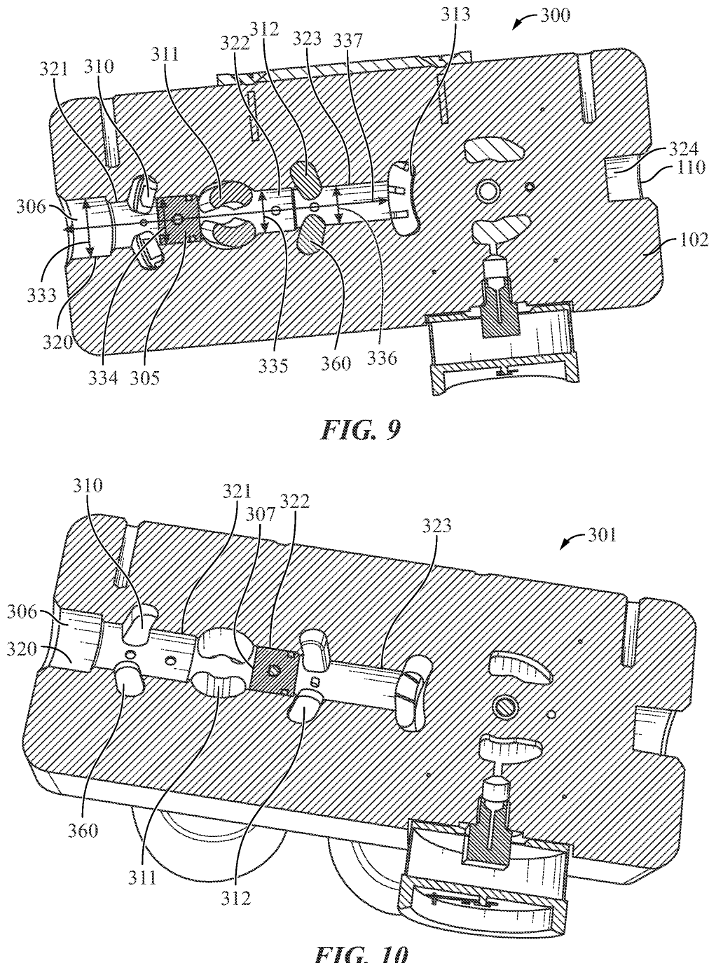

Referring to FIG. 9, the first filter system 300 can include a body 102 that defines a first main channel 306. In some embodiments, the first main channel 306 can be a stepped channel that has a width that decreases along a length 337 of the first main channel 306. The first main channel 306 can have a first portion 320 having a first width 333 that is larger than a second width 334 of a second portion 321 of the first main channel 306. The second width 334 can be larger than a third width 335 of a third portion 322 of the first main channel 306. The third width 335 can be larger than a fourth width 336 of a fourth portion 323 of the first main channel 306. A fifth portion 324 of a second main channel can be in fluid communication with an outlet 110.

The second portion 321 can be constructed and arranged to receive a first plug 305. The first plug 305 can be constructed and arranged to seal (e.g., fluidly seal) the second portion 321, thereby sealing the third portion 322 from the first portion 320. The second portion 321 can receive the first plug between a first secondary channel 310 and a second secondary channel 311 (e.g., between openings thereof).

The first secondary channel 310, the second secondary channel 311, a third secondary channel 312, and a fourth secondary channel 313 can each be in fluid communication with the first main channel 306. A plug 360 can be constructed and arranged to seal the third secondary channel 312 or any other secondary channel. During operation, a fluid can flow from the first secondary channel 310 to the inside 129 of the first container 122 of the first filter assembly 120, flow into and be filtered by the first filter 121, and flow into the second secondary channel 311.

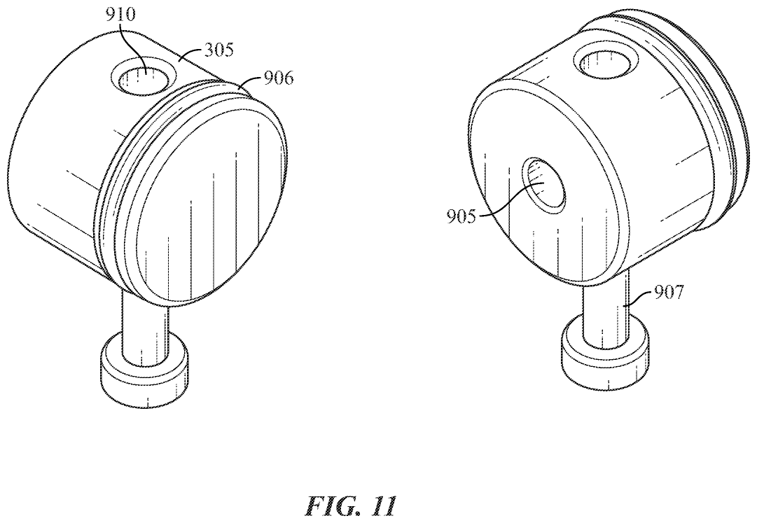

Referring to FIG. 10, the third portion 322 can be constructed and arranged to receive a second plug 307. The second plug 307 can be constructed and arranged to seal (e.g., fluidly seal) the third portion 322, thereby sealing the fourth portion 323 from the second portion 321. The second plug 307 can be received between the second secondary channel 311 and the third secondary channel 312 (e.g., between openings thereof). A plug 360 can be constructed and arranged to seal the first secondary channel 310 or any other secondary channel. During operation, a fluid can flow from the second secondary channel 311 into the second filter 131 of the second filter assembly 130, flow out of and be filtered by the second filter 131, and flow into the third secondary channel 312.

Referring to FIG. 11, a first plug 305 (and/or a second plug 307) can include a seal 906 that is constructed and arranged to seal (e.g., fluidly seal) a portion of a main channel (e.g., third portion 322, fourth portion 323, etc.). The first plug 305 can include a threaded hole 905 that is constructed and arranged to be in threaded communication with a threaded rod (not shown). The threaded rod can be used to install the first plug 305 within the body 102, or to remove the first plug 305 from the body 102. A fastener 907 can be constructed and arranged to fasten the first plug to the body 102. The first plug 305 can include a (e.g., threaded) hole 910 to receive the fastener 907.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a filter system can include: a first plug; a second plug; a first filter assembly including a first filter and a first container; a second filter assembly including a second filter and a second container; a dryer assembly including: an inner container containing at least desiccant material; and an outer container; and a body having an inner surface and an outer surface, the body defining at least: an inlet; an outlet; a main channel having at least a first portion that is in fluid communication with the inlet; a first channel that is constructed and arranged to be in fluid communication with at least the first portion of the main channel and an inside of the first container; a second channel that is constructed and arranged to be in fluid communication with at least a second portion of the main channel and an inside of the first filter; a third channel that is constructed and arranged to be in fluid communication with at least the second portion of the main channel and an inside of the second filter; a fourth channel that is constructed and arranged to be in fluid communication with at least a third portion of the main channel and an inside of the second container; a fifth channel that is constructed and arranged to be in fluid communication with at least the third portion of the main channel and an inside of the outer container of the dryer assembly; a sixth channel that is constructed and arranged to be in fluid communication with at least the outlet and an inside of the inner container of the dryer assembly; a first slot having an opening in the outer surface of the body, wherein the first slot is constructed and arranged to receive the first plug between the first portion and the second portion of the main channel; a second slot having an opening in the outer surface of the body, wherein the second slot is constructed and arranged to receive the second plug between the second portion and the third portion of the main channel; wherein: the first filter is constructed and arranged to be in sealed communication with the body, covering an opening of the second channel, and positioned at least partially inside the first container; the first container is constructed and arranged to be in sealed communication with the body and positioned under the first channel; the second filter is constructed and arranged to be in sealed communication with the body, covering an opening of the third channel, and positioned at least partially inside the second container; the second container is constructed and arranged to be in sealed communication with the body and positioned under the fourth channel; the inner container of the dryer assembly is constructed and arranged to be in sealed communication with the body, covering an opening of the sixth channel, and positioned at least partially inside the outer container of the dryer assembly; the outer container of the dryer assembly is constructed and arranged to be in sealed communication with the body and positioned under the fifth channel.

Variation 2 can include the filter system of variation 1, wherein the first plug is constructed and arranged to fluidly seal the first portion of the main channel from the second portion of the main channel.

Variation 3 can include the filter system of variation 2, wherein the first plug comprises: a first plate having first grooves on a first side thereof; a seal disposed on a second side of the first plate opposite the first side, wherein the seal is constructed and arranged to fluidly seal the first portion of the main channel; a second plate having second grooves on a first side thereof; tapered pins; wherein the first plate and the second plate are constructed and arranged to be joined together so that the first grooves are aligned with the second grooves to form apertures that receive the tapered pins.

Variation 4 can include the filter system of variation 1, wherein the second plug is constructed and arranged to fluidly seal the second portion of the main channel.

Variation 5 can include the filter system of variation 1, wherein the first filter is a first sintered metal filter constructed and arranged to capture solid particles and liquid particles that are approximately 5 microns or larger.

Variation 6 can include the filter system of variation 1, wherein the second filter is a coalescing filter constructed and arranged to capture solid particles and liquid particles that are approximately 0.01 microns or larger.

Variation 7 can include the filter system of variation 1, further comprising a filter status indicator, wherein the filter status indicator comprises: a piston that includes a first portion that is constructed and arranged to be in fluid communication with the second portion of the main channel, wherein the piston further includes a second portion that is constructed and arranged to be in fluid communication with the third portion of the main channel, wherein the piston is constructed and arranged to move toward the third portion of the main channel in response to an increase in a first pressure in the second portion of the main channel relative to a second pressure in the third portion in the main channel.

Variation 8 can include the filter system of variation 1, further comprising first flow guide blades positioned under the first channel and inside the first container, wherein the first flow guide blades are constructed and arranged to guide fluid flowing from the first channel and into the first container so that fluid rotationally flows around the first filter inside the first container.

Variation 9 can include the filter system of variation 1, further comprising a shield constructed and arranged to surround at least a portion of the first filter, wherein the shield is constructed and arranged to condense moisture or water vapor in fluid flowing from the first channel and into the first container.

Variation 10 can include the filter system of variation 1, further comprising a pressure regulator constructed and arranged to be in fluid communication with the outlet of the body.

According to variation 11, a filter system can include: a first plug; a second plug; a first filter assembly including a first filter and a first container; a second filter assembly including a second filter and a second container; a body having an inner surface and an outer surface, the body defining at least: an inlet; an outlet; a main channel having at least a first portion that is in fluid communication with the inlet, the first portion of the main channel having a first width; a first channel that is constructed and arranged to be in fluid communication with at least the first portion of the main channel and an inside of the first container; a second channel that is constructed and arranged to be in fluid communication with at least a second portion of the main channel and an inside of the first filter, the second portion of the main channel having a second width; a third channel that is constructed and arranged to be in fluid communication with at least a third portion of the main channel, the third portion of the main channel having a third width that is smaller than the first width and the second width; a fourth channel that is constructed and arranged to be in fluid communication with at least the third portion of the main channel and an inside of the second filter; a fifth channel that is constructed and arranged to be in fluid communication with the outlet and an inside of the second container; wherein: the first plug is constructed and arranged to fluidly seal the second portion of the main channel; the second portion of the main channel is constructed and arranged to receive the first plug between the first channel and the second channel; the second plug is constructed and arranged to fluidly seal the third channel; the first filter is constructed and arranged to be in sealed communication with the body, covering an opening of the second channel, and positioned inside the first container; the first container is constructed and arranged to be in sealed communication with the body and positioned under the first channel; the second filter is constructed and arranged to be in sealed communication with the body, covering an opening of the fourth channel, and positioned inside the second container; the second container is constructed and arranged to be in sealed communication with the body and positioned under the fifth channel.

Variation 12 can include the filter system of variation 11, wherein the first plug is constructed and arranged to fluidly seal the third portion of the main channel from the first portion of the main channel.

Variation 13 can include the filter system of variation 11, further comprising a fastener, wherein the first plug is constructed and arranged to be fastened to the body by the fastener.

Variation 14 can include the filter system of variation 11, further comprising a third plug, wherein the third portion of the main channel is constructed and arranged to receive the third plug between the second channel and the third channel.

Variation 15 can include the filter system of variation 11, wherein the first filter is a first sintered metal filter constructed and arranged to capture solid particles and liquid particles that are approximately 5 microns or larger.

Variation 16 can include the filter system of variation 11, wherein the second filter is a coalescing filter constructed and arranged to capture solid particles and liquid particles that are approximately 0.01 microns or larger.

Variation 17 can include the filter system of variation 11, further comprising a filter status indicator, wherein the filter status indicator comprises: a piston that includes a first portion that is constructed and arranged to be in fluid communication with the second portion of the main channel, wherein the piston further includes a second portion that is constructed and arranged to be in fluid communication with the third portion of the main channel, wherein the piston is constructed and arranged to move toward the third portion of the main channel in response to an increase in a first pressure in the second portion of the main channel relative to a second pressure in the third portion in the main channel.

Variation 18 can include the filter system of variation 11, further comprising first flow guide blades positioned under the first channel and inside the first container, wherein the first flow guide blades are constructed and arranged to guide fluid flowing from the first channel and into the first container so that fluid rotationally flows around the first filter inside the first container.

Variation 19 can include the filter system of variation 11, further comprising a shield constructed and arranged to surround at least a portion of the first filter, wherein the shield is constructed and arranged to condense moisture or water vapor in fluid flowing from the first channel and into the first container.

Variation 20 can include the filter system of variation 11, further comprising a pressure regulator constructed and arranged to be in fluid communication with the outlet of the body.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

I claim:

1. A filter system comprising:
a first plug;
a second plug;
a first filter assembly including a first filter and a first container;
a second filter assembly including a second filter and a second container;
a dryer assembly including:
an inner container containing at least desiccant material; and
an outer container; and
a body having an inner surface and an outer surface, the body defining at least:
an inlet;
an outlet;
a main channel having at least a first portion that is in fluid communication with the inlet;
a first channel that is constructed and arranged to be in fluid communication with at least the first portion of the main channel and an inside of the first container;
a second channel that is constructed and arranged to be in fluid communication with at least a second portion of the main channel and an inside of the first filter;
a third channel that is constructed and arranged to be in fluid communication with at least the second portion of the main channel and an inside of the second filter;
a fourth channel that is constructed and arranged to be in fluid communication with at least a third portion of the main channel and an inside of the second container;
a fifth channel that is constructed and arranged to be in fluid communication with at least the third portion of the main channel and an inside of the outer container of the dryer assembly;
a sixth channel that is constructed and arranged to be in fluid communication with at least the outlet and an inside of the inner container of the dryer assembly;
a first slot having an opening in the outer surface of the body, wherein the first slot is constructed and arranged to receive the first plug between the first portion and the second portion of the main channel;
a second slot having an opening in the outer surface of the body, wherein the second slot is constructed and arranged to receive the second plug between the second portion and the third portion of the main channel;
wherein:
the first filter is constructed and arranged to be in sealed communication with the body, covering an opening of the second channel, and positioned at least partially inside the first container;
the first container is constructed and arranged to be in sealed communication with the body and positioned under the first channel;
the second filter is constructed and arranged to be in sealed communication with the body, covering an opening of the third channel, and positioned at least partially inside the second container;
the second container is constructed and arranged to be in sealed communication with the body and positioned under the fourth channel;
the inner container of the dryer assembly is constructed and arranged to be in sealed communication with the body, covering an opening of the sixth channel, and positioned at least partially inside the outer container of the dryer assembly;
the outer container of the dryer assembly is constructed and arranged to be in sealed communication with the body and positioned under the fifth channel.

2. The filter system of claim 1, wherein the first plug is constructed and arranged to fluidly seal the first portion of the main channel from the second portion of the main channel.

3. The filter system of claim 1, wherein the first plug comprises:
a first plate having first grooves on a first side thereof;
a seal disposed on a second side of the first plate opposite the first side, wherein the seal is constructed and arranged to fluidly seal the first portion of the main channel;
a second plate having second grooves on a first side thereof;
tapered pins;
wherein the first plate and the second plate are constructed and arranged to be joined together so that the first grooves are aligned with the second grooves to form apertures that receive the tapered pins.

4. The filter system of claim 1, wherein the second plug is constructed and arranged to fluidly seal the second portion of the main channel.

5. The filter system of claim 1, wherein the first filter is a first sintered metal filter constructed and arranged to capture solid particles and liquid particles that are approximately 5 microns or larger.

6. The filter system of claim 1, wherein the second filter is a coalescing filter constructed and arranged to capture solid particles and liquid particles that are approximately 0.01 microns or larger.

7. The filter system of claim 1, further comprising a filter status indicator, wherein the filter status indicator comprises:
a piston that includes a first portion that is constructed and arranged to be in fluid communication with the second portion of the main channel, wherein the piston further includes a second portion that is constructed and arranged to be in fluid communication with the third portion of the main channel, wherein the piston is constructed and arranged to move toward the third portion of the main channel in response to an increase in a first pressure in the second portion of the main channel relative to a second pressure in the third portion in the main channel.

8. The filter system of claim 1, further comprising first flow guide blades positioned under the first channel and inside the first container, wherein the first flow guide blades are constructed and arranged to guide fluid flowing from the first channel and into the first container so that fluid rotationally flows around the first filter inside the first container.

9. The filter system of claim 1, further comprising a shield constructed and arranged to surround at least a portion of the first filter, wherein the shield is constructed and arranged to condense moisture or water vapor in fluid flowing from the first channel and into the first container.

10. The filter system of claim 1, further comprising a pressure regulator constructed and arranged to be in fluid communication with the outlet of the body.

11. A filter system comprising:
a first plug;
a second plug;
a first filter assembly including a first filter and a first container;
a second filter assembly including a second filter and a second container;
a body having an inner surface and an outer surface, the body defining at least:
an inlet;
an outlet;
a main channel having at least a first portion that is in fluid communication with the inlet, the first portion of the main channel having a first width;
a first channel that is constructed and arranged to be in fluid communication with at least the first portion of the main channel and an inside of the first container;
a second channel that is constructed and arranged to be in fluid communication with at least a second portion of the main channel and an inside of the first filter, the second portion of the main channel having a second width;
a third channel that is constructed and arranged to be in fluid communication with at least a third portion of the main channel, the third portion of the main channel having a third width that is smaller than the first width and the second width;
a fourth channel that is constructed and arranged to be in fluid communication with at least the third portion of the main channel and an inside of the second filter;
a fifth channel that is constructed and arranged to be in fluid communication with the outlet and an inside of the second container;
wherein:
the first plug is constructed and arranged to fluidly seal the second portion of the main channel;
the second portion of the main channel is constructed and arranged to receive the first plug between the first channel and the second channel;
the second plug is constructed and arranged to fluidly seal the third channel;
the first filter is constructed and arranged to be in sealed communication with the body, covering an opening of the second channel, and positioned inside the first container;
the first container is constructed and arranged to be in sealed communication with the body and positioned under the first channel;
the second filter is constructed and arranged to be in sealed communication with the body, covering an opening of the fourth channel, and positioned inside the second container;
the second container is constructed and arranged to be in sealed communication with the body and positioned under the fifth channel.

12. The filter system of claim 11, wherein the first plug is constructed and arranged to fluidly seal the third portion of the main channel from the first portion of the main channel.

13. The filter system of claim 11, further comprising a fastener, wherein the first plug is constructed and arranged to be fastened to the body by the fastener.

14. The filter system of claim 11, further comprising a third plug, wherein the third portion of the main channel is constructed and arranged to receive the third plug between the second channel and the third channel.

15. The filter system of claim 11, wherein the first filter is a first sintered metal filter constructed and arranged to capture solid particles and liquid particles that are approximately 5 microns or larger.

16. The filter system of claim 11, wherein the second filter is a coalescing filter constructed and arranged to capture solid particles and liquid particles that are approximately 0.01 microns or larger.

17. The filter system of claim 11, further comprising a filter status indicator, wherein the filter status indicator comprises:
a piston that includes a first portion that is constructed and arranged to be in fluid communication with the second portion of the main channel, wherein the piston further includes a second portion that is constructed and arranged to be in fluid communication with the third portion of the main channel, wherein the piston is constructed and arranged to move toward the third portion of the main channel in response to an increase in a first pressure in the second portion of the main channel relative to a second pressure in the third portion in the main channel.

18. The filter system of claim 11, further comprising first flow guide blades positioned under the first channel and inside the first container, wherein the first flow guide blades are constructed and arranged to guide fluid flowing from the first channel and into the first container so that fluid rotationally flows around the first filter inside the first container.

19. The filter system of claim 11, further comprising a shield constructed and arranged to surround at least a portion of the first filter, wherein the shield is constructed and arranged to condense moisture or water vapor in fluid flowing from the first channel and into the first container.

20. The filter system of claim 11, further comprising a pressure regulator constructed and arranged to be in fluid communication with the outlet of the body.
